(19) United States
(12) Patent Application Publication
(10) Pub. No.: US 2016/0353257 A1
(43) Pub. Date: Dec. 1, 2016

(54) AUTOMATIC NOTIFICATION DEVICE AND AUTOMATIC NOTIFICATION METHOD

(71) Applicant: ASUSTeK COMPUTER INC., Taipei City (TW)

(72) Inventors: Min-Che Huang, Taipei City (TW); Kuo-Chung Chiu, Taipei City (TW); Hsiao-Kai Li, Taipei City (TW); Chia-Hsin Yang, Taipei City (TW); Tsung-Han Tsai, Taipei City (TW); Wei-Chi Yen, Taipei City (TW); Shih-Hao Ke, Taipei City (TW); Shu-Hui Chou, Taipei City (TW); Wei-Ting Lin, Taipei City (TW); Wen-Chieh Tseng, Taipei City (TW); Ting-Yu Chen, Taipei City (TW); Shuan-Yi Chu, Taipei City (TW)

(21) Appl. No.: 15/157,420

(22) Filed: May 18, 2016

(30) Foreign Application Priority Data
May 25, 2015 (CN) 201510270128.4

(51) Int. Cl. H04W 4/12; H04W 68/02; H04W 8/24

(52) U.S. Cl. CPC H04W 4/12; H04W 8/24; H04W 68/02

(57) ABSTRACT

An automatic notification device for communicating with a plurality of electronic device is provided. The automatic notification device includes a controller. The controller determines whether to transfer information to the first electronic device according to a utilizing status of the first electronic device, and receives a determine signal from the first electronic device to determine whether the information transferred to the first electronic device has already been read according to the determine signal. Furthermore, an automatic notification method applied to the automatic notification device is also provided.

### CROSS-REFERENCE TO RELATED APPLICATION

This application claims the priority benefit of China application serial No. 201510270128.4, filed on May 25, 2015. The entirety of the above-mentioned patent application is hereby incorporated by reference herein and made a part of specification.

### BACKGROUND OF THE INVENTION

Field of the Invention

The invention relates to an electronic device and an operation method thereof and, more particularly, to an automatic notification device and an automatic notification method thereof.

Description of the Related Art

Along with development of information and communication technology and popularization of network, info national and digital smart life is a trend. In a so-called smart family life system, electronic devices communicate with each other via Wide Area Network (WAN), Local Area Network (LAN) and/or power network. However, conventionally, a user receives information via a fixed-point device or a portable electronic device, and then the user has to choose an appropriate way to response the information. The conventional method cannot notice users to obtain the information at the right time and the right location according to an operation status of the electronic device.

### BRIEF SUMMARY OF THE INVENTION

According to a first aspect of the present disclosure, an automatic notification device, for communicating with a plurality of electronic devices, comprises: a controller, configured to determining whether to transfer information to a first electronic device of the electronic devices according to a utilizing status of the first electronic device, and to receive a determine signal from the first electronic device to determine whether the information has been read.

According to a second aspect of the present disclosure, an automatic notification method, adapted for controlling an automatic notification device to communicate with a first electronic device of a plurality of electronic devices, comprises: determining whether to transfer information to the first electronic device according to a utilizing status of the first electronic device; and receiving a determine signal from the first electronic device to determine whether the information transferred to the first electronic device has been read or not according to the determine signal.

Based on above, in the embodiment, the automatic notification device executes the automatic notification method and determine whether to transfer information to the electronic device according to the utilizing status of the electronic device to automatic notify the user of the electronic device to obtain the information.

These and other features, aspects and advantages of the present invention will become better understood with regard to the following description, appended claims, and accompanying drawings.

### BRIEF DESCRIPTION OF THE DRAWINGS

FIG. 1 is a schematic diagram of an automatic notification system in a first condition in an embodiment;

FIG. 2 is a block diagram of an automatic notification device in an embodiment;

FIG. 3 is a block diagram of an automatic notification device in an embodiment;

FIG. 4 is a schematic diagram showing an automatic notification system in a second condition in an embodiment;

FIG. 5 is a schematic diagram showing an automatic notification system in a third condition in an embodiment;

FIG. 6 is a flow chart of an automatic notification method in an embodiment; and

FIG. 7 is a flow chart of an automatic notification method in another embodiment.

### DETAILED DESCRIPTION OF THE EMBODIMENTS

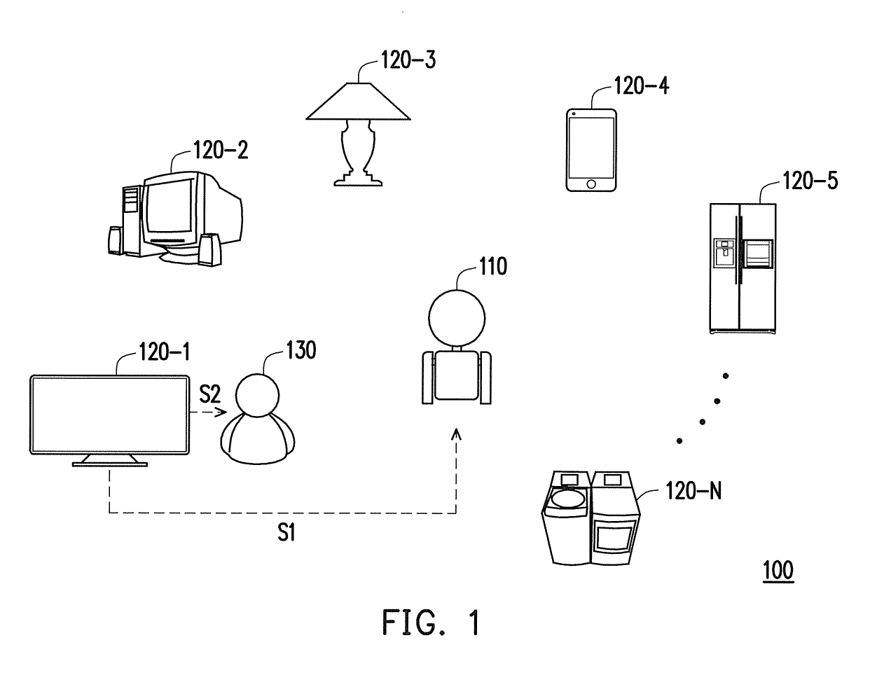

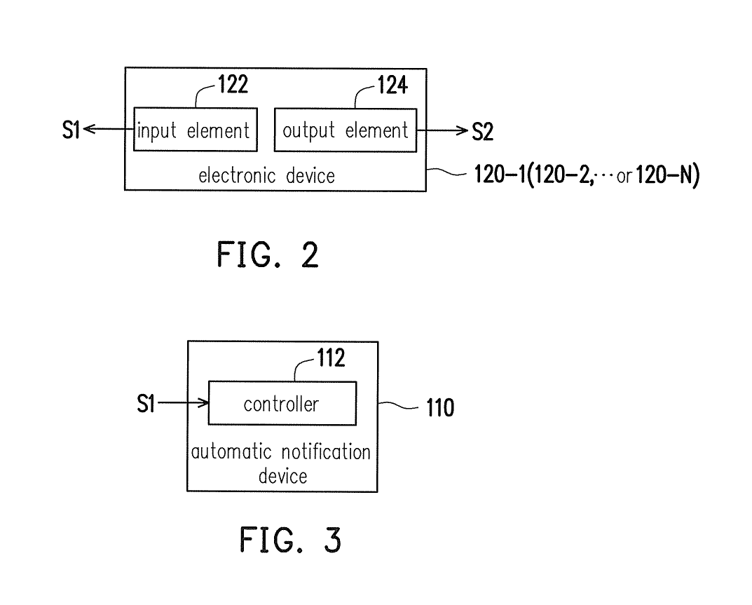

FIG. 1 is a schematic diagram of an automatic notification system in a first condition in an embodiment. FIG. 2 is a block diagram of an automatic notification device in an embodiment. Please refer to FIG. 1 and FIG. 2. An automatic notification system 100 in the embodiment includes at least one automatic notification device 110 and a plurality of electronic devices such as a first electronic device, a second electronic device, and electronic devices other than the first, the second electronic device 120-1 to 120-N, wherein N is a positive integer bigger than 1. In the embodiment, the amount of the electronic devices 120-1 to 120-N is not limited herein. Each electronic device includes an input element and an output element. For example, the first electronic device 120-1 includes an input element 122 and an output element 124, as shown in FIG. 2.

In the embodiment, the automatic notification system 100 is an indoor automatic family life system. In an embodiment, a user 130 is a family member or a visitor to the family, which is not limited herein. The electronic devices 120-1 to 120-N are electronic devices, such as a multi-media player (for example, a television and a stereo system), a household appliance (for example, a washer, a microwave oven, an oven, and a fridge), a light equipment (for example, a desk lamp), or an independent operation electronic device (for example, a desktop computer, a tablet PC, a smart phone, a non-smart phone, a wearable electronic device, a personal digital assistant (PDA), or a notebook computer), which is not limited herein. In the embodiment, the automatic notification device 110 controls and or transfers signal to the electronic devices 120-1 to 120-N via a power network. In an embodiment, the automatic notification device 110 has data exchange with the electronic devices 120-1 to 120-N via wide area network (WAN) and/or local area network (LAN). Furthermore, in the embodiment, the locations of the electronic devices 120-1 to 120-N are only for descriptive representation, which do not represent actual locations or actual distance between the user 130 and the electronic devices 120-1 to 120-N.

In the embodiment, the input element 122 and the output element 124 of different electronic devices are various. In an embodiment, the first electronic device 120-1 is a television, the input element 122 is a power switch or a remote controller of the television, and the output element 124 is a display or a loudspeaker of the television. In an embodiment, the second electronic device 120-2 is a desktop computer, the input element 122 is a keyboard, a mouse, or a touch input interface of the desktop computer, and the output element 124 is a display or a loudspeaker of the desktop computer. In an embodiment, the third electronic device 120-3 is a desk lamp, the input element 122 is a power switch or a touch input interface of the desk lamp for turning on/off or switching light modes of the desk lamp, and the output element 124 is a bulb or a light-emitting diode (LED) light source of the desk lamp. In an embodiment that the fourth electronic device 120-4 is a tablet computer, the input element 122 is a touch input interface of the tablet computer, and the output element 124 is a display interface or a loudspeaker of the tablet computer. In an embodiment, the fifth electronic device 120-5 is a washer, the input element 122 is a power switch, a temperature/humidity sensor, or an operation panel of the washer, and the output element 124 is an operation panel or a display panel of the washer. In an embodiment, the sixth electronic device 120-6 is a fridge, the input element 122 is a power switch, a temperature/humidity sensor, or an operation panel of the fridge, and the output element 124 is an operation panel or a display panel of the fridge. In the embodiments, the electronic device is an automatic home appliance or an electrical home appliance with or without a micro-controller. Types of the electronic devices, the input element, and the output element are only for descriptive representation, which is not limited herein.

In an embodiment, the automatic notification system 100 is an outdoor smart family life system. In an embodiment, at least one of the electronic devices 120-1 to 120-N is a portable or a non-portable electronic device applied in a vehicle intelligent system. The automatic notification device 110 exchanges data with the electronic device applied in vehicle intelligent system via a long-distance communication method, such as Wide Area Network (WAN), to remind the driver or passengers an event.

In an embodiment, the automatic notification device 110 is an electronic device independent from the electronic devices 120-1 to 120-N, such as a smart family processor, an intelligent robot, a central control system, a cloud sever control center, or a desktop computer. In another embodiment, the automatic notification device 110 is a chipset or a processing device integrated in one of the electronic devices 120-1 to 120-N, which is not limited herein.

FIG. 3 is a block diagram of an automatic notification device in an embodiment. Please refer to FIG. 1 and FIG. 3. The automatic notification device 110 of the embodiment includes a controller 112. The automatic notification device 110 further includes an executing module, a storage module, a communication module, and a power module and so on in embodiments. The controller 112 transfers information to the specific electronic device corresponding to the user 130, such as one of the electronic devices 120-1 to 120-N, to inform the user 130 about the information. In the embodiment of FIG. 1, the user 130 can get the information output from the TV when the user watches TV. The controller 112 determines whether to transfer the information to one of the electronic devices according to the utilizing status of the electronic devices 120-1 to 120-N, to inform the user corresponding to the electronic device about the information. When the utilizing status of the electronic device represents that the electronic device is currently under operating, the controller 112 transfers the information to the electronic device that is under operating (that means the electronic device currently busy). In the embodiment, for example, the controller 112 controls the output element 124 of the electronic device to transmit a notification signal S2 to the user corresponding to the electronic device notification signal. Furthermore, the controller 112 receives a determine signal S1 from the input element 122 of the electronic device, to determine whether the information transferred to the electronic device has been read according to the determine signal S1.

In an embodiment, the first electronic device 120-1 is the television, when the user 130 watches TV currently, that is, the utilizing status of the first electronic device 120-1 is “under operating”. If an emergency event happens and cannot notify the urgent information to the user 130 via other electronic device (such as a cell phone), the controller 112 determines to transfer the urgent information to the first electronic device 120-1 to inform the user 130 about the information. In the embodiment, the busy electronic device 120-1 represents that the user 130 probably concentrate on the electronic device 120-1, or be able to obtain the output information from the electronic device 120-1. Therefore, when the utilizing status of the electronic device 120-1 is busy, the controller 112 determines to transfer the information to the electronic device 120-1. Thus, in the embodiment, the controller 112 controls the busy electronic device 120-1 to display the information (the information is regarded as an automatic notification for the user 130) on its screen. In an embodiment, when the utilizing status of the first electronic device 120-1 is not under operating (or not busy), the controller 112 determines to transfer the information to other electronic devices that is under operating, or determines not to transfer the information to the non-busy (not under operating) electronic device 120-1.

Then, in the embodiment, when the information is transferred to the first electronic device 120-1, the controller 112 receives the determine signal S1 from the input element 122. In the embodiment, the user 130 sends out the determine signal S1 via the input element 122 of the first electronic device 120-1 to inform the controller 112 that the information has been read. For example, the user 130 uses the power button of the television, the desk lamp, the washer, or the fridge, the remote controller of the television, the keyboard or the mouse of the desktop computer, the touch input interface of the desktop computer, the desk lamp, or the tablet computer, or the temperature/humidity sensor of the washer or the fridge to transmit the determine signal S1, to inform the controller 112 about that the information has been read by the user 130.

In an embodiment, if the information transferred to the electronic device 120-1 has not yet been read, the controller 112 controls the first electronic device 120-1 to continuously output the notification signal S2 to inform the user 130 the information until the information has been read. Taking the television for example, the way of the first electronic device 120-1 continuously outputting the notification signal S2 is to display the information on the screen continuously or at intervals.

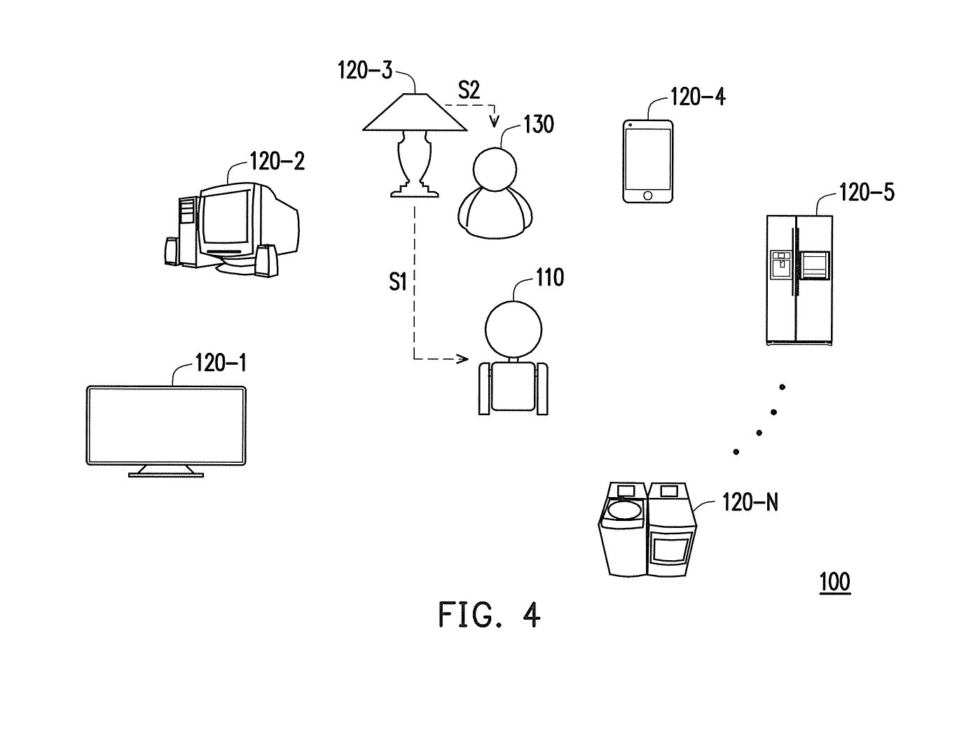

FIG. 4 is a schematic diagram showing an automatic notification system in a second condition in an embodiment. Please refer to FIG. 4. In the embodiment, the third electronic device 120-3 is a desk lamp, and the user 130 is near the electronic device 120-3 and is able to be notified with the information that outputted from the desk lamp. In the embodiment, the information outputted from the desk lamp includes the flash frequency of the light or the illuminant parameters such as color or brightness.

In an embodiment, when the utilizing status of the first electronic device 120-1 and the third electronic device 120-3 are both determined to be under operating, the controller 112 chooses to transfer the information to the first electronic device 120-1. In an embodiment, when the information transferred to the first electronic device 120-1 has not yet been read, the controller transfer the information to other electronic devices 120-2 to 120-N sequentially or randomly until the information has been read, or until all the electronic devices 120-1 to 120-N or a specific number of the electronic devices receive the information. In an embodiment, when the information transferred to the first electronic device 120-1 is not yet been read, the controller 112 chooses to transfer the information by the first electronic device 120-1 to the electronic device 120-3 directly. That is to say, when the utilizing status of at least two of the electronic devices 120-1 to 120-N is determined to be under operating, the controller 112 may transfer the unread information by one busy electronic device to the other busy electronic device directly. In an embodiment, once the unread information is transferred from the first electronic device 120-1 to the third electronic device 120-3, the controller 112 controls the first electronic device 120-1 continuously transmitting the notification signal S2 to inform the user 130 about the information, or the controller 112 controls the first electronic device 120-1 to stop transmitting the notification signal S2 to inform the user 130, and the third electronic device 120-3, instead of the first electronic device 120-1, informs the user 130 about the information. In the embodiment, the user corresponding to the first electronic device 120-1 and the third electronic device 120-3 is a same user 130.

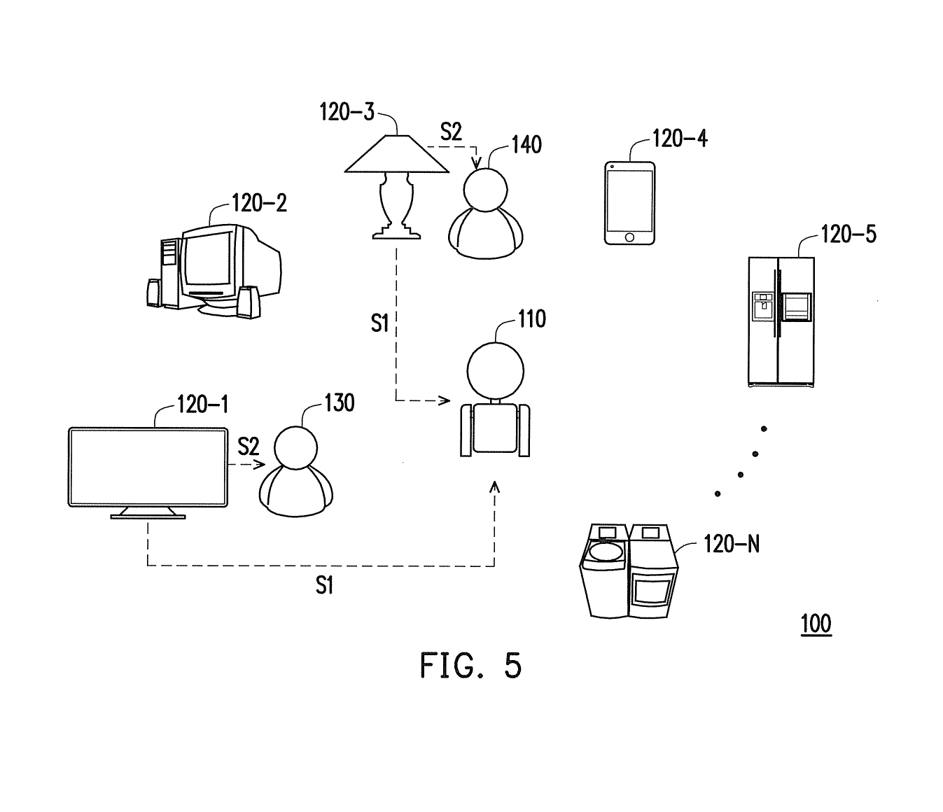

FIG. 5 is a schematic diagram showing an automatic notification system in a third condition in an embodiment. Please refer to FIG. 5. In the embodiment, the user 130 in the automatic notification system 100 corresponds to the electronic device 120-1, and the user 140 in the automatic notification system 100 corresponds to the electronic device 120-3. Therefore, users corresponding to the electronic device 120-1 and the electronic device 120-3 are different.

In the embodiment, if the information transferred to the electronic device 120-1 is not read by the user 130, the controller 112 transfers the information which is not read by the electronic device 120-1 to the electronic device 120-3 for informing the user 140 about the information. In the embodiment, once the unread information is transferred from the electronic device 120-1 to the electronic device 120-3, the controller 112 controls the electronic device 120-1 to continuously transmit the notification signal S2 for informing the user 130 about the information, moreover, the controller 112 also controls the electronic device 120-3 to inform the user 140 about the information, or, the controller 112 controls the electronic device 120-1 to stop transmitting the notification signal S2 to inform the user 130, and the electronic device 120-3, instead of the electronic device 120-1, informs the user 140 about the information. Then, after the user 140 obtains the information, the user 140 informs the user 130 about the information.

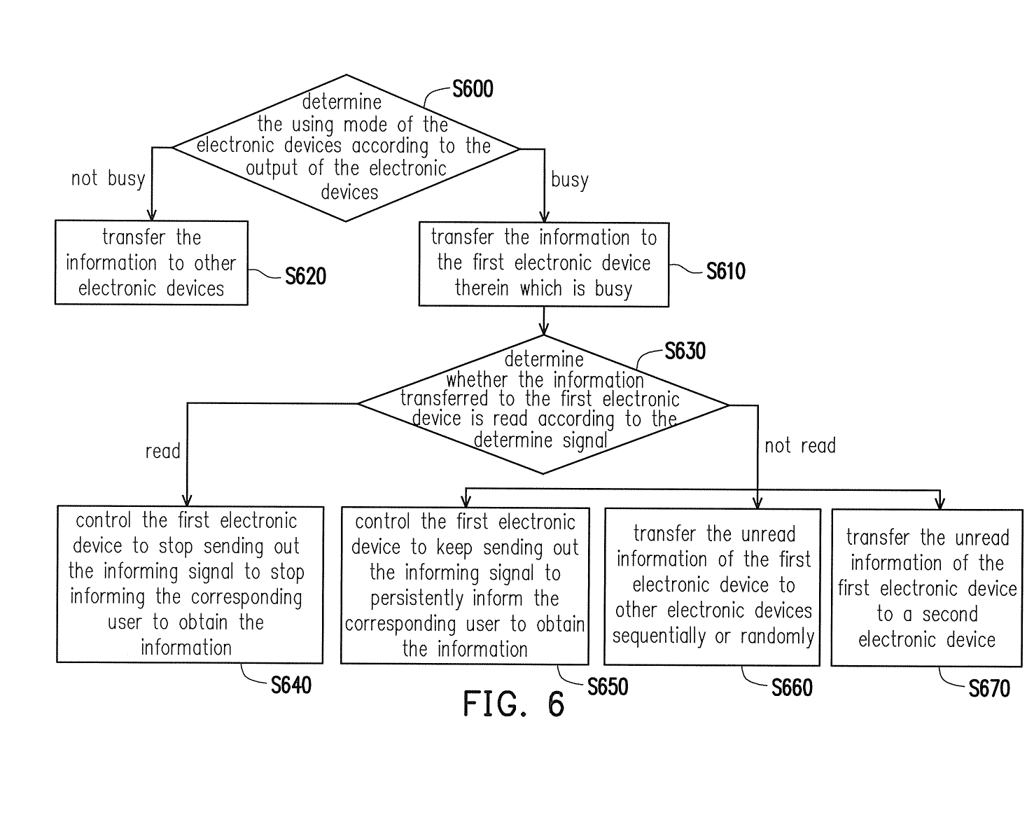

FIG. 6 is a flow chart of an automatic notification method in an embodiment. Please refer to FIGS. 1 and 6. The automatic notification method in the embodiment is applied to the automatic notification system of FIG. 1, or executed by the automatic notification device 110 in FIG. 1. In the embodiment, the automatic notification method includes the following steps. Step S600 is to determine the utilizing status of the electronic devices 120-1 to 120-N according to the output of the electronic devices 120-1 to 120-N. In an embodiment, the controller 112 determines the utilizing status of the electronic devices 120-1 to 120-N according to the output of the electronic devices 120-1 to 120-N. In the embodiment, the output form of the electronic devices 120-1 to 120-N includes the output from the display or a loud speaker of the television, the desktop computer, and/or the tablet computer, the light from the bulb or a LED light source of the desk lamp, the output from the operation panel or the display of the washer and the fridge, and the sound generated during operating the electronic device, which is not limited herein.

When a first electronic device (such as the electronic device 120-1) is determined to be busy, step S610 is to transfer the information to the first electronic device. In an embodiment, if a first electronic device (such as the electronic device 120-1) is determined to be busy, the controller 112 transfers the information to the first electronic device. Otherwise, if the first electronic device is not busy, step S620 is to transfer the information to other electronic devices (such as at least one of the electronic devices 120-2 to 120-N). In an embodiment, if the first electronic device is not busy, the controller 112 transfers the information to other electronic devices (such as at least one of the electronic devices 120-2 to 120-N). Then, step S630 is to determine whether the information transferred to the first electronic device is already read according to the determine signal S1. In an embodiment, the controller 112 determines whether the information transferred to the first electronic device is already read according to the determine signal S1. When it is determined that the information has been read, step S640 is to control the first electronic device to stop sending out the notification signal S2 to stop informing the corresponding user about the information. In an embodiment, When it is determined that the information has been read, the controller 112 controls the first electronic device to stop sending out the notification signal S2 to stop informing the corresponding user about the information. Otherwise, when the information is not read, the controller 112 chooses to execute one of steps S650, S660, S670.

Step S650 is to control the first electronic device to continuously transmitting the notification signal S2 to inform the corresponding user about the information until that the information has been read. In an embodiment, the controller 112 controls the first electronic device to continuously transmitting the notification signal S2 to inform the corresponding user about the information until that the information has been read. Step S660 is to transfers the unread information of the first electronic device to other electronic devices sequentially or randomly until that the information has been read, or until all the electronic devices or specific number of the electronic devices have received the information. In an embodiment, the controller 112 transfers the unread information of the first electronic device to other electronic devices sequentially or randomly until that the information has been read, or until all the electronic devices or specific number of the electronic devices have received the information. Step S670 is to transfer the unread information of the first electronic device 120-1 to a second electronic device in the electronic devices 120-2 to 120-N. In an embodiment, the controller 112 transfers the unread information of the first electronic device to a second electronic device in the electronic devices 120-2 to 120-N. The utilizing status of the second electronic device is busy or not busy.

The steps in FIG. 6 are an embodiment for illustration, the sequence of the steps is not limited herein. The automatic notification method in the embodiment also can refer to the description of FIG. 1 to FIG. 5, which is omitted herein.

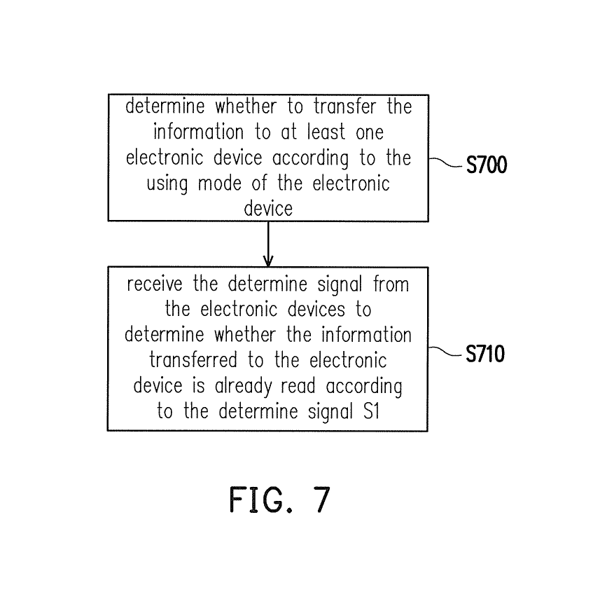

FIG. 7 is a flow chart of an automatic notification method in another embodiment. Please refer to FIGS. 1 and 7. The automatic notification method in the embodiment is able to be applied to the automatic notification system of FIG. 1, or be executed by the automatic notification device 110 in FIG. 1. In the embodiment, the automatic notification method includes the following steps. Step S700 is to determine whether to transfer the information to the electronic device according to the utilizing status of at least one of the electronic devices 120-1 to 120-N. In an embodiment, the controller 112 determines whether to transfer the information to the electronic device according to the utilizing status of at least one of the electronic devices 120-1 to 120-N. Step S710 is to receive the determine signal S1 from at least one of the electronic devices 120-1 to 120-N, to determine whether the information transferred to the electronic device is already read according to the determine signal S1. In an embodiment, the controller 112 receives the determine signal S1 from at least one of the electronic devices 120-1 to 120-N, to determine whether the information transferred to the electronic device is already read according to the determine signal S1.

In sum, in the embodiments, the automatic notification device executes the automatic notification method to determine whether to transfer the information to the electronic device according to the utilizing status of the electronic device. The processing statuses of different electronic devices are determined according to different ways. Furthermore, the automatic notification device can get whether the information transferred to the electronic device is already read. Therefore, the automatic notification device can remind the user to obtain the information in time.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An automatic notification device, for communicating with a plurality of electronic devices, comprising:
a controller, configured to deter mining whether to transfer information to the first electronic device of the electronic devices according to a utilizing status of the first electronic device, and to receive a determine signal from the first electronic device to determine whether the information has been read.

2. The automatic notification device according to claim 1, wherein the first electronic device includes an input element and an output element, the controller controls the output element of the first electronic device to output notification signal, and the controller receives the determine signal from the input element of the first electronic device.

3. The automatic notification device according to claim 2, wherein when the controller determines that the information transferred to the first electronic device has been read according to the determine signal, the controller controls the first electronic device to stop outputting the notification signal, and when the controller determines that the information transferred to the first electronic device has not yet been read according to the determine signal, the controller controls the first electronic device to continuously output the notification signal.

4. The automatic notification device according to claim 1, wherein when the controller determines that the information transferred to the first electronic device has not yet been read, the controller transfers the unread information to a second electronic device of the electronic devices.

5. The automatic notification device according to claim 4, wherein the controller keeps transferring the unread information to the second electronic device until the controller determines that the unread information has been read by the second electronic devices according to the determine signal.

6. The automatic notification device according to claim 4, wherein the controller transfers the unread information to other electronic devices other than the first electronic device and the second electronic device, until the controller determines that all the electronic devices receive the information according to the determine signal.

7. The automatic notification device according to claim 1, wherein the controller transfers the information to the first electronic device when the utilizing status of the first electronic device is busy.

8. An automatic notification method, adapted for controlling an automatic notification device to communicate with a first electronic device of a plurality of electronic devices, comprising:
determining whether to transfer information to the first electronic device according to a utilizing status of the first electronic device; and
receiving a determine signal from the first electronic device to determine whether the information transferred to the first electronic device has been read or not according to the determine signal.

9. The automatic notification method according to claim 8, further comprising:
controlling the first electronic device to stop outputting the notification signal when the controller determines that the information transferred to the first electronic device has been read according to the determine signal; and
controlling the electronic device to continuously transmit the notification signal if the controller determines that the information transferred to the first electronic device has not yet been read according to the determine signal.

10. The automatic notification method according to claim 8, further comprising:
transferring the unread information of the first electronic device to a second electronic devices of the electronic devices sequentially or randomly when the controller determines that the information transferred to the first electronic device has not yet been read according to the determine signal.

11. The automatic notification method according to claim 10, wherein the unread information of the first electronic device is transferred to the second electronic devices sequentially or randomly until the controller determines that the information has been read according to the determine signal.

12. The automatic notification method according to claim 10, wherein the unread information of the first electronic device is transferred to other electronic devices of other than the first electronic device and the second electronic device sequentially or randomly until the controller determines that all the electronic devices has already received the information according to the determine signal.

13. The automatic notification method according to claim 8, wherein the step of determining whether to transfer information to the first electronic device according to the utilizing status of the first electronic device comprises transferring the information to the first electronic device when the utilizing status of the first electronic device is busy.
